(19) United States
(12) Patent Application Publication
(10) Pub. No.: US 2015/0339310 A1
(43) Pub. Date: Nov. 26, 2015

(54) SYSTEM FOR RECOMMENDING RELATED-CONTENT ANALYSIS IN AN AUTHORING ENVIRONMENT

(71) Applicants: Andreas Kurt PURSCHE, Singapore (SG); Tobias Andreas NESTLER, Dresden (DE)

(72) Inventors: Andreas Kurt PURSCHE, Singapore (SG); Tobias Andreas NESTLER, Dresden (DE)

(21) Appl. No.: 14/281,911

(22) Filed: May 20, 2014

(51) Int. Cl. G06F 17/30

(52) U.S. Cl. CPC G06F 17/3097; G06F 17/30731; G06F 17/30867

(57) ABSTRACT

Disclosed herein are technologies for recommending related-content analysis in a text document authoring environment. In some implementations, a matched related-content is generated on-the-fly to a user based on a context-based analysis of user-entries in the text document authoring environment. This Abstract is submitted with the understanding that it will not be used to interpret or limit the scope or meaning of the claims.

### TECHNICAL FIELD

The present disclosure relates generally to a method of recommending related-content analysis in a text document authoring environment.

### BACKGROUND

Many business processes require a specification or documentation of information, knowledge and data. For example, the specification or documentation of information is in the form of Microsoft Office Word or Excel.

Following given templates or document structures of arbitrary complexity, users need to fill out documents by entering all requested data. In many cases the requested information is either semantically similar or even identical to what has been entered in other previous documents. However, paragraphs or sections containing the semantically similar content may have not been necessarily created by the same person working on the same document nor might the person be aware of them. More often, the users do not consider searching for existing content in the first place and even if they do so, finding semantically similar content in other documents, downloading and opening them, and incorporating the content into the current document constitutes a time consuming and inefficient process.

For example, in a Request for Proposal (RFP) document, a vendor has to respond to the RIP document to provide the requested information. A customer asking for information from multiple sellers/reviewers, using a semi-structured, semi-formal document format may be confronted with several hundred or even thousands of questions about particular aspects of an offered product or service (e.g. financial, legal, technical requirements). To this end, a user-friendly application may be implemented to enhance efficiency of the user when working, for example, on the details of the UP document.

### SUMMARY

Disclosed herein is a framework for recommending related-content analysis in a text document authoring environment. One aspect of the present framework includes receiving a user-input and analyzing a structure of the user-input to determine a related-content. The matched related-content may be displayed, and the analyzed structure may be stored in a database.

In accordance with another aspect, the framework includes an input interface that receives a user-input, an observer component that analyzes a structure of the user-input, and a database connector that receives a matched related-content. A user-interface (UI) may further be provided to display the matched related-content. The analyzed structure may be stored in a database.

This summary is provided to introduce a selection of concepts in a simplified form that are further described below in the following detailed description. It is not intended to identify features or essential features of the claimed subject matter, nor is it intended that it be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an exemplary recommender system as described in present implementations herein;

FIGS. 2A and 2B illustrate an exemplary recommender view and a compare view, respectively, as described in present implementations herein;

FIG. 3 illustrates an exemplary process for implementing, at least in part, the technologies described herein; and

FIG. 4 illustrates an exemplary computing system to implement in accordance with the technologies described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies for recommending related-content analysis in a text document authoring environment. Examples of users include individuals, business or corporate entities, etc. Technologies herein may be applied to computing and mobile applications.

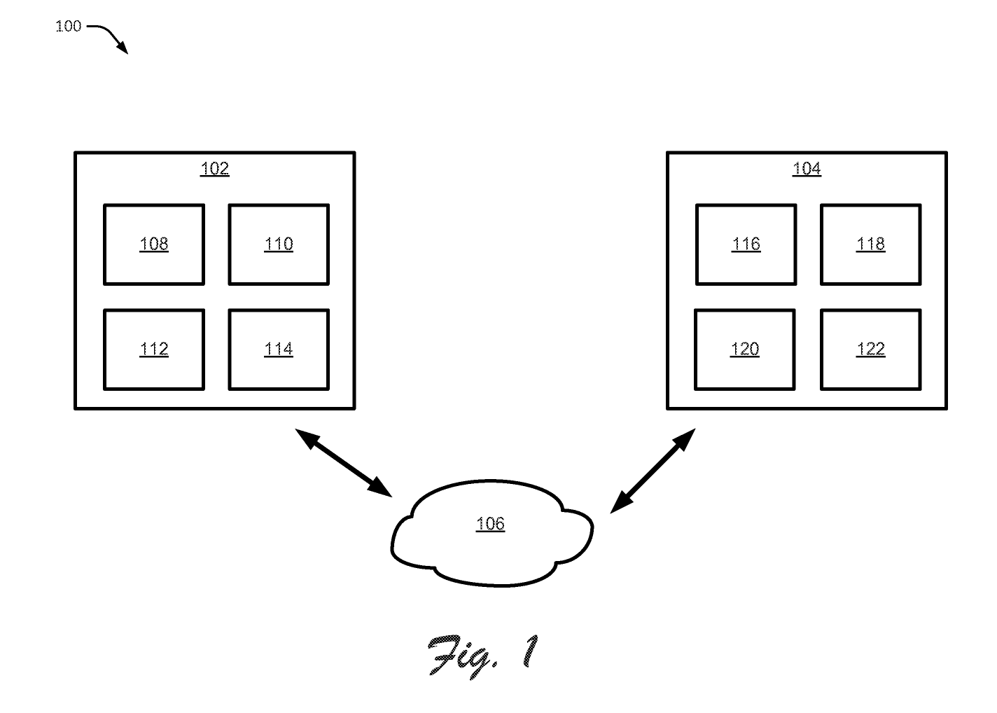

FIG. 1 shows an exemplary recommender system 100 as described in present implementations herein. As shown, the recommender system 100 includes a client 102, a server 104, and a network 106 that provides a communication link between the client 102 and the server 104. Furthermore, the client 102 has a document observer component 108, database connector 110, recommender view 112 and a compare view 114. On the other hand, the server 104 has a session management component 116, a matcher component 118, a system connector 120 and an update manager component 122.

As an initial overview of the recommender system 100, a user (not shown), for example, signs in at the client side and enters a few words to a particular text document (e.g., request-for-proposal bidding document). The observer component 108 continuously extracts context-based keywords or key phrases from user-entries relative to a status, identification, and other information of the user. Based from these keywords or key phrases, the database connector 110 may—on the fly—generate semantically similar contents to the recommender view 112 and the compare view 114. The database connector 110 utilizes the server 104 that stores known structures (i.e., related contents) related to the particular text document. The user may then utilize the recommender view 112 that displays matched related-contents and/or the compare view 114 that displays a comparison between the related-contents and the user-entries to the particular text document. During the process, the server 104 continuously updates its database with regard to any structure changes in the particular text document.

Examples of such client 102 may include (but are not limited to) a mobile phone, a cellular phone, a smartphone, a personal digital assistant, a tablet computer, a netbook, a notebook computer, a laptop computer, a multimedia playback device, a digital music player, a digital video player, a navigational device, a digital camera, and the like.

In an implementation, the client 102 may run different mobile web applications in its browser or operating system. One of the mobile web applications, for example, may implement the recommender system 100 at the client side. In this example, the implementation may utilize a text document authoring environment where the user signs in and opens a particular text document. For example, the user is a product or a service customer and the text document is related to eliciting bids from potential product or service vendors. In this example, the web application that implements the recommender system 100 may assist the user in composing, editing, assembling and/or managing elicited bids from the potential product or service vendors.

As an example of present implementations herein, the database connector 110 may connect with an underlying High-Performance Analytic Appliance (HANA) database in order to store content, content type, granularity and context information of the text document (e.g., request-for-proposal text document). In this example, the context information may include links to third-party customer relationship management (CRM), to persons associated with or involved in previous related documents, etc.

The above RANA database may be implemented or found, for example, at the server side (i.e., server 104). At the server 104, the session management component 116 facilitates a connection between the client 102 and the underlying HANA database that may be found at the server 104. Particularly, the session management component 116 facilitates a connection between the user—working on the text document—and the HANA database that stores known structures, previous analysis on the text document, related information and contents, etc. For example, the known structures includes headings of sections and sub-sections, metadata information about the text document, links to a CRM system, links to human resources (HR) department, and the like.

With the user connected to the HANA database, the matcher component 118 may implement a matching algorithm that constantly matches the context-based key words and key phrases—derived by the observer component 108 at the client side—against stored structures or related contents in the HANA database. For example, the matching algorithm analyzes, compares and/or matches the analyzed structure by using thresholds or degrees of matching in order to find semantically similar text passages. In this example, the matching algorithm may be able to filter and fetch the related contents with highest degree of possible matching with regard to the observed keywords or key-phrases from the text document. Furthermore, candidates for successful matches are identified at real-time and ranked based on identified topics and all available context information.

In an implementation, the update manager component 122 may be configured to handle real-time notifications to the user or client in case of successful matches. For example, the update manager component 122 communicates the successful matches to the client 102 through the database connector 110. In this example, the database connector 110 may forward the received successful matches to the recommender view 112 and the compare view 114. In an implementation, the recommender view 112 and the compare view 114 may be further configured to display or generate different comparison formats, presentation, etc. with regard to displaying of the successful matches.

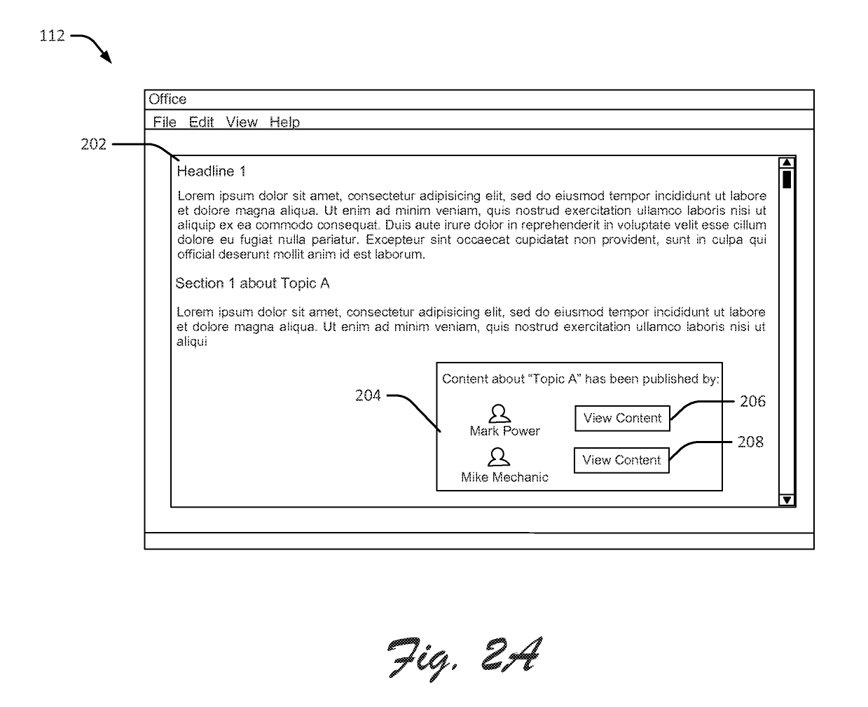

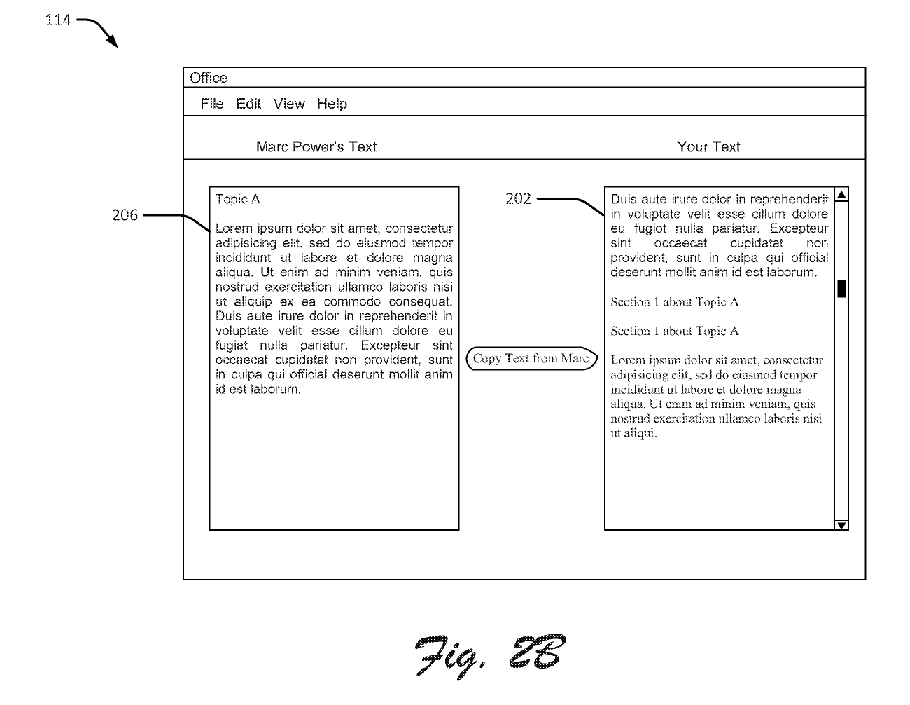

FIGS. 2A and 2B show an exemplary implementation of the recommender view 112 and the compare view 114, respectively.

In an implementation, the recommender system 100 analyzes the structure of the user-entries to the text document at the client side and compares the structure against known related document structures, which are stored in the content database at the server side. The analyzed structure may include, for example, context-based key headings of sections and sub-sections, and available meta-information about the text document. In this example, the analyzed structure may further be linked to the CRM system, HR system, etc, in order to describe the context in which the text document is created. The CRM system, for example, is a separate business data storage system or software that may enhance the structure analysis of the text document. On the other hand, other information may be derived, for example, from the HR system such as a job title, department, associated positions, etc. of the author, user, and other persons associated to the text document.

As shown, the recommender view 112 illustrates user-entries 202, and a related-content display 204. Furthermore, the related-content display 204 further illustrates a first related content 206 and a second related content 208. The first and second related contents 206 and 208 include, for example, the filtered related contents with higher degrees of matching based from a matching degree threshold.

For example, while the user types words and phrases to the user-entries 202, the observer component 108 system constantly analyzes the content of entered words and phrases and compares the derived context-based analysis with the related-contents from the database in order to find semantically similar passages in other text documents. Furthermore, the observer component 108 may be configured to communicate to the server the type of content (e.g., text, table, graphics, etc.) and structured granularity of the context-based analysis (e.g., whole text, paragraph, section, sub-section). That is, the stored contents at the database may, for example, facilitate differentiations between sections dealing with independent topics, headings, etc. The higher the granularity in storing the derived context-based analysis, the more efficient will be the observer component 108 in the recognition of the related-contents. In addition, the recommender system 100 and particularly, the observer component 1108, may offer the user an option to tag the text document in order to improve the detection mechanism.

In case of a successful match, the system recommends the document containing the semantically similar content to the user as illustrated in FIGS. 2A and 2B. For example, in FIG. 2A, the user may view the first and second related contents 206 and 208 in a dialog box where the user is typing words and phrases. In this example, the first and second related contents 206 and 208 may include the highest order of possible matching based from identification of the user, background of the user, context of the user-entries 204, and the like.

With continuing reference to FIG. 2B, FIG. 2B shows the compare view 114 with the selected first related content 206 that is displayed beside user-entries 202. For example, the user selects the first related content 206 in FIG. 2A and the contents of the first related content 206 are then displayed in the compare view 114. In this example, the user may copy the contents of the selected first related content 206 to a text document authoring environment.

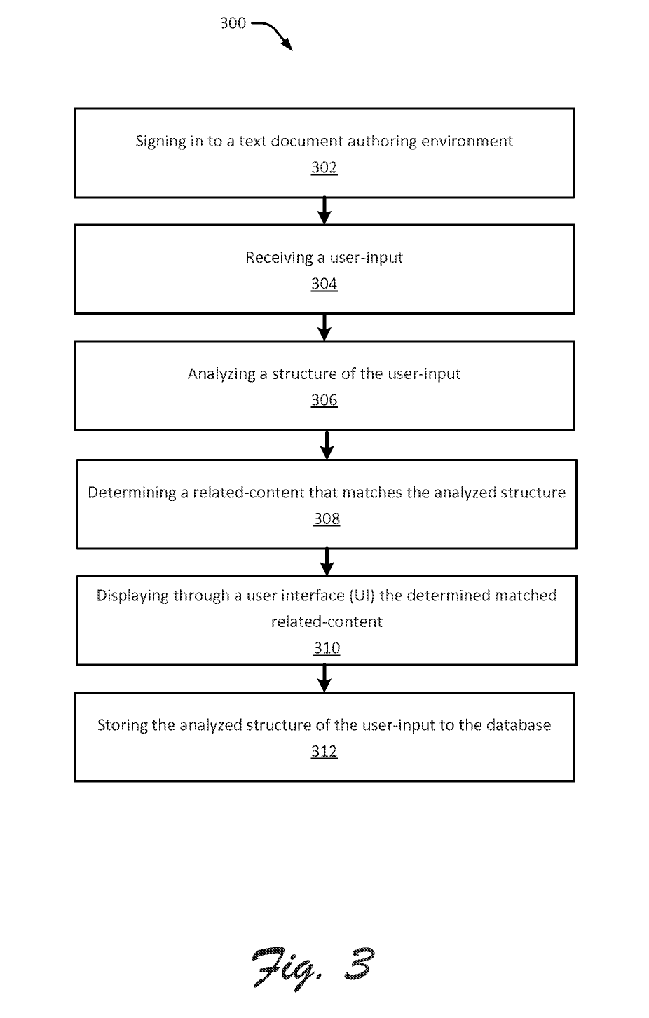

FIG. 3 illustrates an exemplary process 300 for implementing, at least in part, the technology described herein. In particular, process 300 depicts a flow to implement a method recommending related-content analysis in a text document authoring environment. The process 300 may be performed by a computing device or devices. An exemplary architecture of such a computer device is described below with reference to FIG. 3. In this particular example, the process 300 describes that certain acts are be performed at or by a user or a system.

At 302, signing in to a text document authoring environment is performed. For example, a user signs in to an application in a portable device (e.g., client 102) that implements a recommender system (e.g., recommender system 100) at client side as described above.

At 304, receiving a user-input is performed. For example, user-entries (e.g., user-entries 202) are received by the client 102.

At 306, analyzing a structure of the user-input is performed. For example, an observer component (e.g., observer component 108) continuously extracts context-based keywords or key phrases from the user-entries 202 relative to a status, identification, and other information of the user. Based from these keywords or key phrases, a database connector (e.g., database connector 110) may—on the fly—utilize a server (e.g., server 104) that stores known structures (i.e., related contents) related to the particular text document.

At 308, determining a related-content that matches the analyzed structure is performed. For example, a matcher component (e.g., matcher component 118) at the server 104 may implement an algorithm to determine successful candidates that highly matches the analyzed structure of the user-entries 202. The algorithm utilizes a matching threshold in order to filter out related contents that are lower in matching-rank as compared to the analyzed structure of the user-entries 202. In this example, the above threshold matches are determined to be the successful candidates.

At 310, displaying through a user-interface (UI) the determined matched related-content is performed. For example, the user may then utilize the recommender view 112 that displays matched related-contents and/or the compare view 114 that displays a comparison between the related-contents and the user-entries to the particular text document.

At 312, storing the analyzed structure of the user-input to the database is performed. During the process of working on the text document by the user, the server 104 continuously updates its database with regard to any structure changes in the particular text document. In one implementation, the structure changes may be stored in different granular levels in order to distinguish topics of individual sections or subsections, headings, and the like, and their associated subject matter experts. In this example, the structure analysis may facilitate context-based differentiation of different user inputs.

For example, in the RFP document as described above, one or more paragraphs in the text document may have different topics, which are barely related to each other. In other words, there may be a paragraph, for example, about a “carbon-footprint” of SAP in 2013, which falls under Vendor Information-Sustainability while another paragraph may talk about “customer-references,” which do not fall under the coverage of the Vendor Information-Sustainability. In this example, it may not be necessary to consider one question as separate from the other; however, considerations may be made on the context in which the topic was raised. In this regard, the granular level of the known structures may help the user in a situation where, for example, the user is particularly interested in a very specific part of a large RFP document.

In another implementation, the client 102 may include its own database for storing of the structure changes.

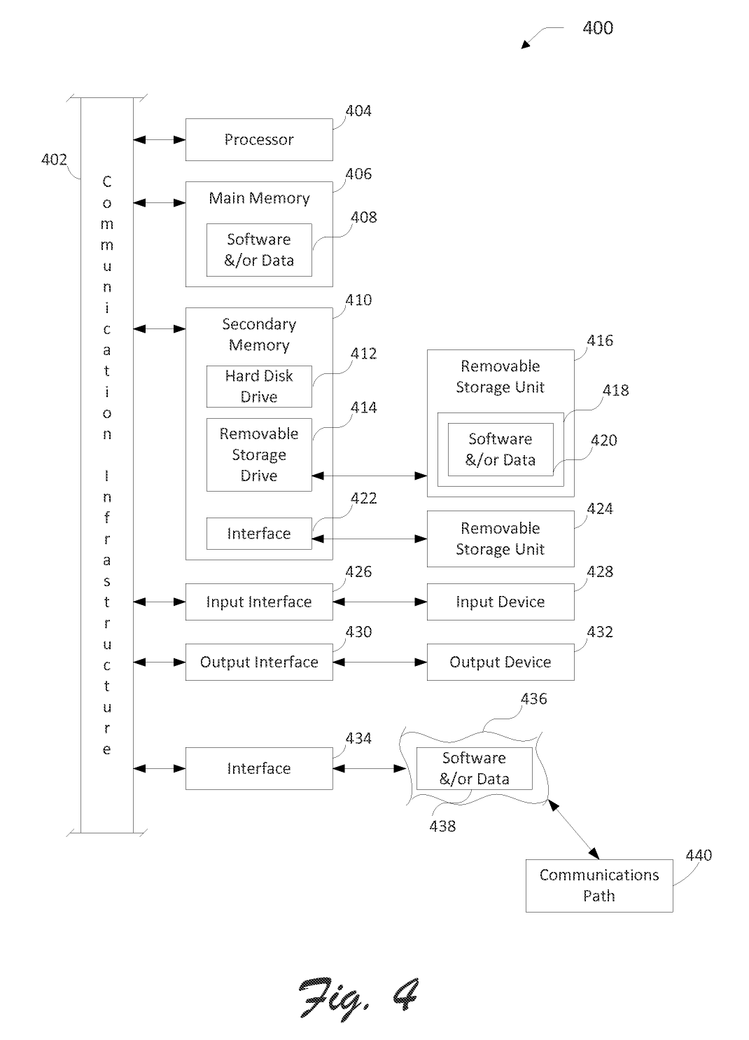

FIG. 4 illustrates an exemplary system 400 that may implement, at least in part, the technologies described herein. The computer system 400 includes one or more processors, such as processor 404. Processor 404 can be a special-purpose processor or a general-purpose processor. Processor 404 is connected to a communication infrastructure 402 (for example, a bus or a network). Depending upon the context, the computer system 400 may also be called a client device.

Computer system 400 also includes a main memory 406, preferably Random Access Memory (RAM), containing possibly inter alia computer software and/or data 408.

Computer system 400 may also include a secondary memory 410. Secondary memory 410 may include, for example, a hard disk drive 412, a removable storage drive 414, a memory stick, etc. A removable storage drive 414 may comprise a floppy disk drive, a magnetic tape drive, an optical disk drive, a flash memory, or the like. A removable storage drive 414 reads from and/or writes to a removable storage unit 416 in a well-known manner. A removable storage unit 416 may comprise a floppy disk, a magnetic tape, an optical disk, etc. which is read by and written to by removable storage drive 414. As will be appreciated by persons skilled in the relevant art(s) removable storage unit 416 includes a computer usable storage medium 418 having stored therein possibly inter alia computer software and/or data 420.

In alternative implementations, secondary memory 410 may include other similar means for allowing computer programs or other instructions to be loaded into computer system 400. Such means may include, for example, a removable storage unit 424 and an interface 422. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 424 and interfaces 422 which allow software and data to be transferred from the removable storage unit 424 to computer system 400.

Computer system 400 may also include an input interface 426 and a range of input devices 428 such as, possibly inter alia, a keyboard, a mouse, etc.

Computer system 400 may also include an output interface 430 and a range of output devices 432 such as, possibly inter alia, a display, one or more speakers, etc.

Computer system 400 may also include a communications interface 434. Communications interface 434 allows software and/or data 438 to be transferred between computer system 400 and external devices. Communications interface 434 may include a modem, a network interface (such as an Ethernet card), a communications port, a Personal Computer Memory Card International Association (PCMCIA) slot and card, or the like. Software and/or data 438 transferred via communications interface 434 are in the form of signals 436 which may be electronic, electromagnetic, optical, or other signals capable of being received by communications interface 434. These signals 436 are provided to communications interface 434 via a communications path 440. Communications path 440 carries signals and may be implemented using a wire or cable, fiber optics, a phone line, a cellular phone link, a Radio Frequency (RF) link or other communication channels.

As used in this document, the terms “computer-program medium,” “computer-usable medium,” and “computer-readable medium” generally refer to media such as removable storage unit 416, removable storage unit 424, and a hard disk installed in hard disk drive 412. Computer program medium and computer usable medium can also refer to memories, such as main memory 406 and secondary memory 410, which can be memory semiconductors (e.g. Dynamic Random Access Memory (DRAM) elements, etc.). These computer program products are means for providing software to computer system 400.

Computer programs (also called computer control logic) are stored in main memory 406 and/or secondary memory 410. Such computer programs, when executed, enable computer system 400 to implement the present technology described herein. In particular, the computer programs, when executed, enable processor 404 to implement the processes of aspects of the above. Accordingly, such computer programs represent controllers of the computer system 400. Where the technology described herein is implemented, at least in part, using software, the software may be stored in a computer program product and loaded into computer system 400 using removable storage drive 414, interface 422, hard disk drive 412 or communications interface 434.

The technology described herein may be implemented as computer program products comprising software stored on any computer useable medium. Such software, when executed in one or more data processing devices, causes data processing device(s) to operate as described herein. Exemplary illustrations of the technology described herein may employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), and nanotechnological storage device, etc.).

A computing system may take the form of any combination of one or more of inter alia a wired device, a wireless device, a mobile phone, a feature phone, a smartphone, a tablet computer (such as for example an iPad™), a mobile computer, a handheld computer, a desktop computer, a laptop computer, a server computer, an in-vehicle (e.g., audio, navigation, etc.) device, an in-appliance device, a Personal Digital Assistant (PDA), a game console, a Digital Video Recorder (DVR) or Personal Video Recorder (PVR), a cable system or other set-top-box, an entertainment system component such as a television set, etc.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted simplified to clarify the description of the exemplary implementations.

The inventors intend the described exemplary implementations to be primarily examples. The inventors do not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more exemplary illustrations described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

What is claimed is:

1. A method of recommending related-content analysis in a text document authoring environment, the method comprising:
receiving a user-input;
analyzing a structure of the user-input;
determining a related-content that matches the analyzed structure;
displaying the matched related-content; and
storing the analyzed structure in a database.

2. The method according to claim 1, wherein the structure comprises key words, key phrases, a key paragraph or context-based semantics, wherein the structure is further linked to a user's identification or location.

3. The method according to claim 2, wherein the context-based semantics comprises information relating to an author of a document, a type of the document, potential customer for the document, solutions, services or products that are referred to by the document.

4. The method according to claim 1, wherein the analyzing comprises extracting context-based key words and key phrases from the user-input.

5. The method according to claim 1, wherein the analyzing comprises linking extracted context information to another enterprise social network or context information.

6. The method according to claim 1, wherein the determining of the related-content utilizes a matching threshold that filters the related-content to be displayed.

7. The method according to claim 1, wherein the storing of the analyzed structure of the user-input is implemented at a granular level.

8. The method according to claim 1, wherein the storing comprises a direct integration into the text document authoring environment of the extracted context information.

9. The method according to claim 1, wherein the storing comprises tagging, by the user, the analyzed structure.

10. A device comprising:
an input interface that receives a user-input;
an observer component that analyzes a structure of the user-input;
a database connector that receives a matched related-content;
a user-interface (UI) that displays the matched related-content; and
a database that stores the analyzed structure.

11. The device according to claim 10, wherein the observer component extracts context-based key words, key phrases, a key paragraph or a context-based semantics, wherein the structure is further linked to a user's identification or location.

12. The device according to claim 11, wherein the context-based semantics comprises information relating to an author of a document, a type of the document, potential customer for the document, solutions, services or products that are referred to by the document.

13. The device according to claim 10, wherein the database stores the analyzed structure of the user-input at a granular level.

14. The device according to claim 10, the database connector receives the matched related-content that is determined by using a matching threshold to find successful candidates for higher-degree of matching.

15. The device according to claim 10, wherein the user-interface (UI) displays a recommender view and a compare view.

16. One or more non-transitory computer-readable media storing processor-executable instructions that when executed cause one or more processors to perform operations that present system scenarios comprising:
signing-in to a text document authoring environment by a user;
receiving a user-input;
analyzing a structure of the user-input;
determining a related-content that matches the analyzed structure;
displaying on-the-fly the matched related-content; and
storing the analyzed structure in a database.

17. The one or more non-transitory computer-readable media according to claim 16, wherein the structure comprises key words, key phrases, a key paragraph or a context-based semantics, wherein the structure is further linked to a user's identification or location.

18. The one or more non-transitory computer-readable media according to claim 17, wherein the context-based semantics comprise information relating to an author of a document, a type of the document, potential customer for the document, solutions, services or products that are referred to by the document.

19. The one or more non-transitory computer-readable media according to claim 16, wherein the storing of the analyzed structure of the user-input is implemented at a granular level.

20. The one or more non-transitory computer-readable media according to claim 16, wherein the analyzing comprises extracting context-based key words and key phrases from the user-input.
